(19) United States
(12) Patent Application Publication
(10) Pub. No.: US 2013/0050190 A1
(43) Pub. Date: Feb. 28, 2013

(54) DRESSING SIMULATION SYSTEM AND METHOD

(71) Applicants: HOU-HSIEN LEE, Tu-Cheng (TW); CHANG-JUNG LEE, Tu-Cheng (TW); CHIH-PING LO, Tu-Cheng (TW)

(72) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/313,008

(22) Filed: Dec. 7, 2011

(30) Foreign Application Priority Data
Aug. 25, 2011 (TW) 100130444

(51) Int. Cl. G06T 15/00

(52) U.S. Cl. 345/419

(57) ABSTRACT

In a dressing simulation method, a three dimensional (3D) image of a user is captured. A 3D image of a garment is selected from a website of a garment vendor. One or more portions of the garment are determined in the 3D image of the garment, and one or more portions of the user are determined in the 3D image of the user. Each of the portions of the garment is respectively correlated with one determined portion of the user. The 3D image of the user is synthesized with the 3D image of the garment by covering the 3D image of the garment with the 3D image of the user and by overlapping each portion of the garment with one of the determined portions of the user correlated with the determined portion of the garment, to obtain a virtual 3D image of the user trying on the garment.

### BACKGROUND

1. Technical Field

Embodiments of the present disclosure relate generally to image processing technologies, and particularly to a dressing simulation system and method using 3D images of users.

2. Description of Related Art

Electronic commerce is becoming more and more popular. Many people like to purchase garments through the internet. One problem inherent with garment purchases over the internet is the inability to try a garment on before it is purchased. In some solutions, a user can choose from a predetermined set of models of the human body to fit the garments. However, some particular characteristics between the models and the user itself are different, that may cause the user to purchase unsatisfactory garments. Therefore, a more efficient dressing simulation system and method is desired.

### BRIEF DESCRIPTION OF THE DRAWINGS

FIG. 1 is a schematic diagram illustrating one embodiment of a computing device comprising a dressing simulation system.

FIG. 2 is a block diagram of one embodiment of functional modules of the dressing simulation system of FIG. 1.

FIG. 3 is a schematic diagram illustrates an example of determined portions of a user and a garment.

FIG. 4 is a flowchart of one embodiment of a dressing simulation method implemented by the dressing simulation system of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

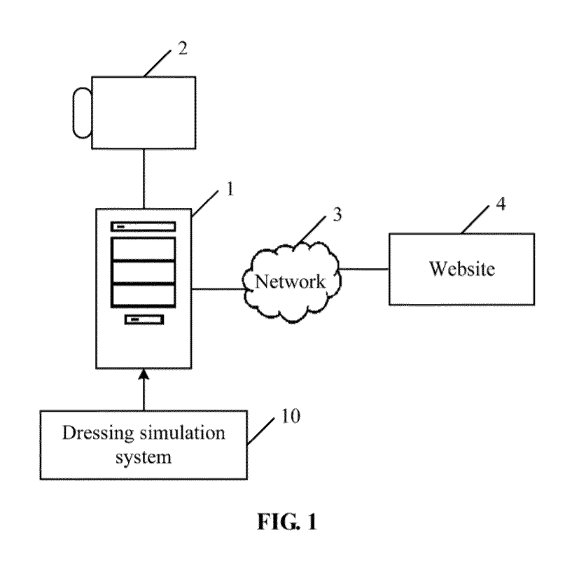

FIG. 1 is a schematic diagram illustrating one embodiment of a computing device 1 comprising a dressing simulation system 1. In one embodiment, the computing device 1 electronically connects to an image capturing device 2. The computing device 1 can access a website 4 of a garment vendor through a network 3. The network 3 may be the Internet or other communication networks. The dressing simulation system 10 captures a three dimensional (3D) image of a user, and synthesizes the 3D images of the user and a 3D images of a garment downloaded from the website 4, to obtain a virtual 3D image of the user trying on the garment. The computing device 1 may be, for example, a server or a computer. FIG. 1 is only one example of the computing device 1 that more or fewer components than those shown in the embodiment can be included, or a different configuration of the various components.

The image capturing device 2 may be a digital camera, such as a time of flight (TOF) camera, that can capture 3D images of the user. In one embodiment, the 3D image includes a distance data between the image capturing device 2 and the user.

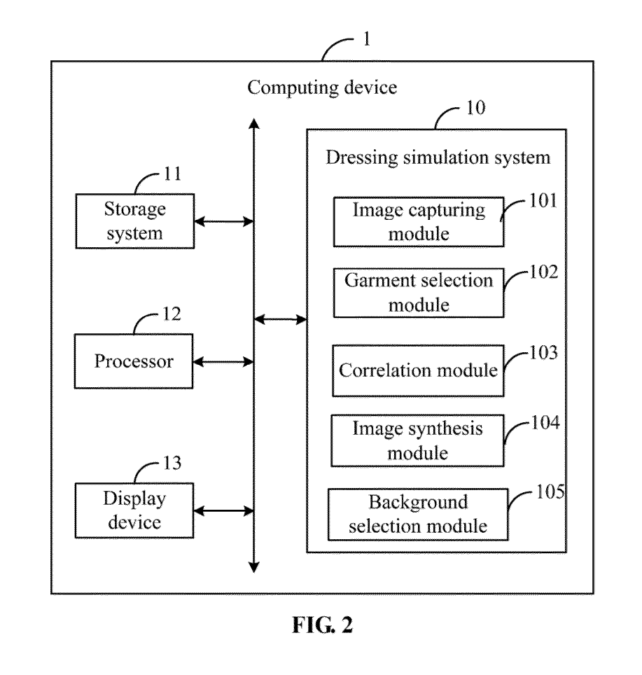

FIG. 2 is a block diagram of one embodiment of functional modules of the dressing simulation system 10 of FIG. 1. In one embodiment, the dressing simulation system 10 may include a plurality of software programs in the form of one or more computerized instructions stored in a storage system 11 and executed by a processor 12 of the computing device 1, to perform operations of the computing device 1. In the embodiment, the dressing simulation system 10 includes an image capturing module 101, a garment selection module 102, a correlation module 103, an image synthesis module 104, and a background image synthesis module. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The image capturing module 101 captures a 3D image of the user using the image capturing device 2.

The garment selection module 102 selects a 3D image of a garment from the website 4 of the garment vendor, and downloads the 3D image of the garment to the storage system 11. In one embodiment, the garment vendor may provide a plurality of 3D images of different garments through the website 4. The user can select a 3D image of a proper garment according to her/his body dimensions through manipulation of the garment selection module 102.

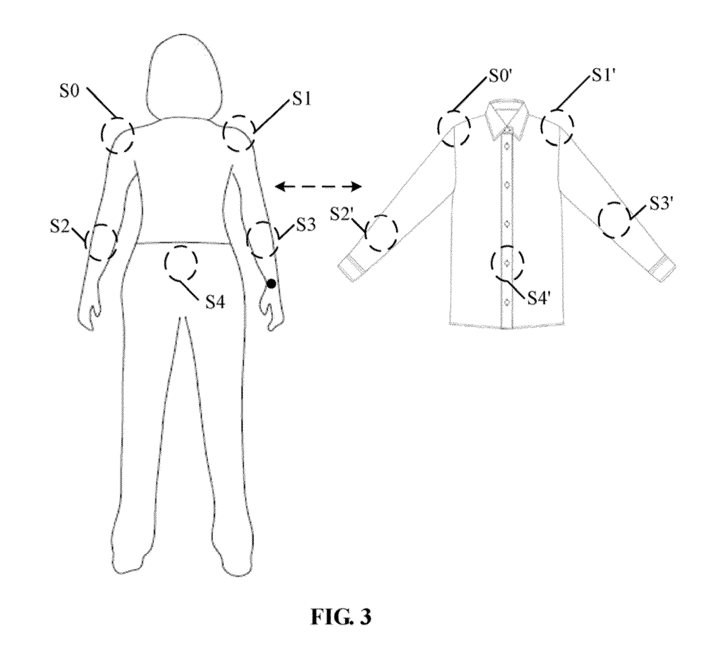

The correlation module 103 determines one or more portions of the garment in the 3D image of the garment, such as the portions S0′, S1′, S2′, S3′, and S4′ of FIG. 3, and determines one or more portions of the user in the 3D image of the user corresponding to the one or more portions of the garment, such as the portions S0, S1, S2, S3, and S4 of FIG. 3. In the embodiment, the amount and positions of the determined portions of the garment and the user is determined according to user requirements. The correlation module 103 further respectively correlates each of the determined portions of the garment with one of the determined portions of the user.

The image synthesis module 104 synthesizes the 3D image of the user with the 3D image of the garment, to obtain a virtual 3D image of the user trying on the garment. In one embodiment, the 3D image of the user is synthesized with the 3D image of the garment by covering the 3D image of the garment with the 3D image of the user, and by overlapping each of the determined portions of the garment with one of the determined portions of the user that is correlated with the determined portion of the garment. For example, the portion S0′ covers with the portion S0, S1′ covers with the portion S1, . . . , and S4′ covers with the portion S4. The image synthesis module 104 further displays the synthesized 3D image on a display device 13 of the computing device 1, so that the user can determine whether to purchase the garment according to the synthesized 3D image.

The background selection module 105 selects a 3D background image of a particular scene from the storage system 11. In the embodiment, one or more 3D background images of one or more particular scenes are prestored in the storage system 11. When the 3D background image is selected, the image synthesis module 104 synthesizes the obtained virtual 3D image with the selected 3D background image to generate a virtual 3D image of the user trying on the garment in the particular scene. Then the generated virtual 3D image is displayed on the display device 13, so that the user can purchase different garments that fit different occasions.

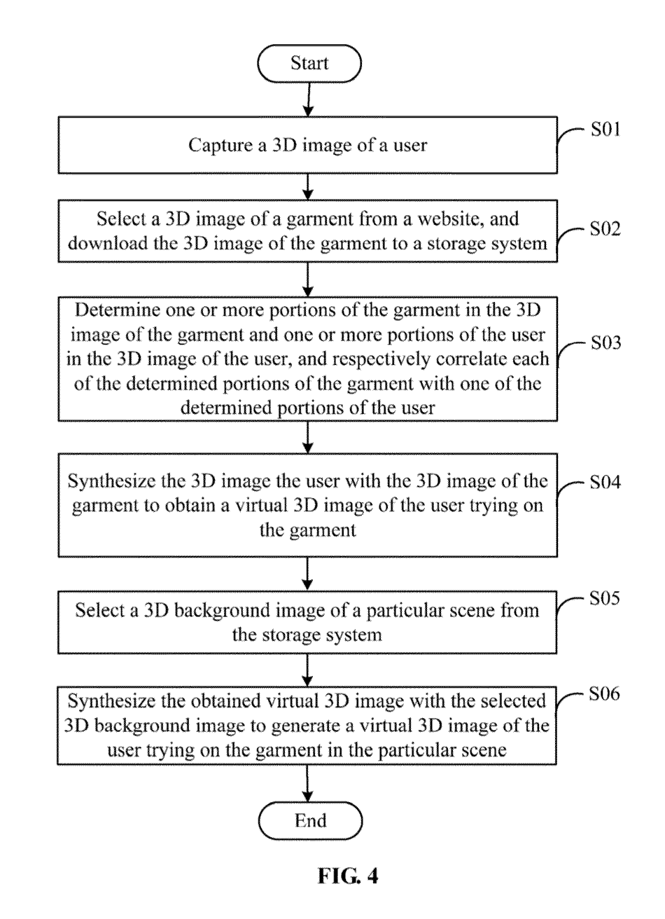

FIG. 4 is a flowchart of one embodiment of a dressing simulation method implemented by the dressing simulation system 10 of FIG. 1. In one embodiment, the method can simulate a process of a user trying on a garment. Depending on the embodiment, additional blocks may be added, others removed, and the ordering of the blocks may be changed.

In block S01, the image capturing module 101 captures a 3D image of the user using the image capturing device 2.

In block S02, the garment selection module 102 selects a 3D image of a garment from the website 4 of the garment vendor, and downloads the 3D image of the garment to the storage system 11. In one embodiment, the garment vendor may provide a plurality of 3D images of different garments through the website 3. The user can select a 3D image of a proper garment according to her/his own body dimensions through the garment selection module 102.

In block S03, the correlation module 103 determines one or more portions of the garment in the 3D image of the garment and one or more portions of the user in the 3D image of the user corresponding to the one or more portions of the garment, and respectively correlates each of the determined portions of the garment with one of the determined portions of the user, such as the portions S0′, S1′, S2′, S3′, and S4′ of the garment are respectively correlated with the portions S0, S1, S2, S3, and S4 of the user.

In block S04, the image synthesis module 104 synthesizes the 3D image of the user with the 3D image of the garment, to obtain a virtual 3D image of the user trying on the garment. In one embodiment, the 3D image of the user is synthesized with the 3D image of the garment by covering the 3D image of the garment with the 3D image of the user, and by overlapping each of the determined portions of the garment with one of the determined portions of the user that is correlated with the determined portion of the garment. The image synthesis module 104 further displays the obtained 3D image on the display device 13 of the computing device 1, so that the user can determine whether to purchase the garment according to the synthesized 3D image.

In block S05, the background selection module 105 selects a 3D background image of a particular scene from the storage system 11. In the embodiment, one or more 3D background images of one or more particular scenes are prestored in the storage system 11.

In block S06, the image synthesis module 104 synthesizes the obtained virtual 3D image with the selected 3D background image to generate a virtual 3D image of the user trying on the garment in the particular scene. Then the generated virtual 3D image is displayed on the display device 13, so that the user can purchase different garments that fit different occasions.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A dressing simulation method implemented by a computing device, the method comprising:
capturing a three dimensional (3D) image of a user using an image capturing device that is electronically connected to the computing device;
selecting a 3D image of a garment from a website of a garment vendor, and downloading the 3D image of the garment to a storage system of the computing device;
determining one or more portions of the garment in the 3D image of the garment and one or more portions of the user in the 3D image of the user corresponding to the one or more portions of the garment, and respectively correlating each of the determined portions of the garment with one of the determined portions of the user; and
synthesizing the 3D image of the user with the 3D image of the garment by covering the 3D image of the garment with the 3D image of the user and by overlapping each of the determined portions of the garment with one of the determined portions of the user that is correlated with the determined portion of the garment, to obtain a virtual 3D image of the user trying on the garment.

2. The method according to claim 1, further comprising:
displaying the obtained 3D image on a display device of the computing device.

3. The method according to claim 1, further comprising:
selecting a 3D background image of a particular scene from the storage system;
synthesizing the obtained virtual 3D image with the selected 3D background image to generate a virtual 3D image of the user trying on the garment in the particular scene; and
displaying the generated virtual 3D image on the display device.

4. The method according to claim 1, wherein the image capturing device is a time of flight (TOF) camera.

5. A computing device that is electronically connected to an image capturing device, the computing device comprising:
a display device;
a storage system;
at least one processor;
one or more programs stored in the storage system and executed by the at least one processor, the one or more programs comprising:
an image capturing module operable to capture a three dimensional (3D) image of a user using the image capturing device;
a garment selection module operable to select a 3D image of a garment from a website of a garment vendor, and download the 3D image of the garment to the storage system;
a correlation module operable to determine one or more portions of the garment in the 3D image of the garment and one or more portions of the user in the 3D image of the user corresponding to the one or more portions of the garment, and respectively correlate each of the determined portions of the garment with one of the determined portions of the user; and
an image synthesis module operable to synthesize the 3D image of the user with the 3D image of the garment by covering the 3D image of the garment with the 3D image of the user and by overlapping each of the determined portions of the garment with one of the determined portions of the user that is correlated with the determined portion of the garment, to obtain a virtual 3D image of the user trying on the garment.

6. The computing device according to claim 5, wherein the image synthesis module is further operable to display the obtained 3D image on the display device.

7. The computing device according to claim 5, wherein the one or more programs further comprise:
a background selection module operable to select a 3D background image of a particular scene from the storage system.

8. The computing device according to claim 7, wherein image synthesis module is further operable to synthesize the obtained virtual 3D image with the selected 3D background image to generate a virtual 3D image of the user trying on the garment in the particular scene, and display the generated virtual 3D image on the display device.

9. The computing device according to claim 5, wherein the image capturing device is a time of flight (TOF) camera.

10. A non-transitory storage medium storing a set of instructions, the set of instructions capable of being executed by a processor of a computing device, cause the computing device to perform a dressing simulation method, the method comprising:
capturing a three dimensional (3D) image of a user using an image capturing device that is electronically connected to the computing device;
selecting a 3D image of a garment from a website of a garment vendor, and downloading the 3D image of the garment to a storage system of the computing device;
determining one or more portions of the garment in the 3D image of the garment and one or more portions of the user in the 3D image of the user corresponding to the one or more portions of the garment, and respectively correlating each of the determined portions of the garment with one of the determined portions of the user; and
synthesizing the 3D image of the user with the 3D image of the garment by covering the 3D image of the garment with the 3D image of the user and by overlapping each of the determined portions of the garment with one of the determined portions of the user that is correlated with the determined portion of the garment, to obtain a virtual 3D image of the user trying on the garment.

11. The non-transitory storage medium according to claim 10, wherein the method further comprises:
displaying the obtained 3D image on a display device of the computing device.

12. The non-transitory storage medium according to claim 10, wherein the method further comprises:
selecting a 3D background image of a particular scene from the storage system;
synthesizing the obtained virtual 3D image with the selected 3D background image to generate a virtual 3D image of the user trying on the garment in the particular scene; and
displaying the generated virtual 3D image on the display device of the computing device.

13. The non-transitory storage medium according to claim 10, wherein the image capturing device is a time of flight (TOF) camera.
